(19) United States
(12) Patent Application Publication
(10) Pub. No.: US 2025/0279703 A1
(43) Pub. Date: Sep. 4, 2025

(54) SEGMENTED ROTARY TRANSFORMER HAVING A LARGE DIAMETER

(71) Applicant: SAFRAN ELECTRICAL & POWER, Blagnac (FR)

(72) Inventors: Djemouai HADJIDJ, Blagnac (FR); Rachid BELFKIRA, Blagnac (FR); Frédéric MEER, Blagnac (FR); Jean-Michel Bernard Paul CHASTAGNIER, Blagnac (FR)

(73) Assignee: SAFRAN ELECTRICAL & POWER, Blagnac (FR)

(21) Appl. No.: 18/857,619

(22) PCT Filed: Apr. 19, 2023
(86) PCT No.: PCT/FR2023/050559

§ 371 Date: Oct. 17, 2024

(30) Foreign Application Priority Data
Apr. 25, 2022 (FR) 2203815

(51) Int. Cl. H02K 11/042

(52) U.S. Cl. CPC H02K 11/042

(57) ABSTRACT

Rotating transformer intended to be installed around a shaft movable in rotation, the rotating transformer consisting of a plurality of stator annular sectors and a plurality of rotor annular sectors, the juxtaposition of these annular sectors forming a stator ring and a rotor ring consisting of elementary stator and rotor magnetic circuits including outer and inner magnetic cores and first and second electrical windings to allow a transfer of electrical energy by electromagnetic induction between the stator and rotor rings, the inner and outer magnetic cores being separated by the same air gap present on either side of the inner magnetic core and at least the outer magnetic cores have expansions at the level of the air gap to avoid a discontinuity of the magnetic field lines during the rotation of the movable shaft.

### TECHNICAL FIELD

The present invention relates to the field of power transfer between a fixed reference frame and a rotating reference frame for the electrical de-icing of the propeller airfoils of an aircraft turbomachine and relates to a single-phase rotating transformer used for the transmission of electrical energy by electromagnetic induction between first and second electrical windings of this transformer.

### PRIOR ART

On the electric or hybrid aircrafts as on the conventional aircrafts, there are several surfaces to be protected against ice on the fixed and rotating portions of the turbomachine. The protection envisaged for the rotating portions is generally exclusively electrothermal based on electric heating mats formed of resistance webs covering the surfaces to be protected.

To ensure the transfer of power and therefore convey the electrical energy from the fixed portion to the rotating portion where the electric heating mats are installed, it is known to use a device called “slip ring” whose principle consists in rubbing several fixed conductive rings secured to the fixed portion on circular conductive tracks and secured to the rotating portion, in order to create an electrical connection between the fixed portion and the rotating portion of the turbomachine.

Moreover, it is known that due to the harsh (thermal, electromagnetic and vibrational) environment existing in the hybrid aircrafts including many electrified engine loads, the integration of the electrical equipment is a major challenge and must meet multiple constraints related to both an accessibility for the mounting/dismounting and a routing of the power cables with large bending radii and servitudes such as the cooling.

There is therefore a current need for a reliable and long-life solution for transferring power from a fixed reference frame to a rotating reference frame applicable to large diameter rotation shafts and in compliance with the constraints of a Line Replaceable Unit (LRU) under the wing.

### DISCLOSURE OF THE INVENTION

The main aim of the present invention therefore is a large-diameter rotating transformer, segmented into quarters, whose maintenance is facilitated and does not interfere with the other systems and modules of the aircraft turbomachine, despite its installation in a confined, constrained and hardly accessible area. Another aim is to allow industrialization of this rotating transformer at a lower cost and by limiting the waste of materials during manufacture.

These aims are achieved by a rotating transformer intended to be installed around a shaft movable in rotation, the rotating transformer consisting of a plurality of outer stator annular sectors and a plurality of inner rotor annular sectors, the juxtaposition over 360° of these outer stator and inner rotor annular sectors forming an outer stator ring and an inner rotor ring consisting of a set of elementary stator and rotor magnetic circuits, each of the elementary stator magnetic circuits including an outer magnetic core and a first electrical winding and each of the elementary rotor magnetic circuits including an inner magnetic core and a second electrical winding to allow a transfer of electrical energy by electromagnetic induction between the outer stator and inner rotor rings, the inner and outer magnetic cores being separated by two air gaps present on either side of the inner magnetic core, characterized in that at least the outer magnetic cores have expansions at the level of each of the two air gaps to avoid a discontinuity of the magnetic field lines during the rotation of the movable shaft and in that the inner rotor annular sectors are identical and interchangeable with each other.

Thus, with this contactless power transfer, an improvement in the reliability, service life and operating cost of the transformer is obtained. In addition, better accessibility to the transformer is possible, facilitating its integration into the systems and modules of the aircraft turbomachine. Such a rotating transformer is advantageously used for the electrical de-icing of the propeller airfoils of an aircraft turbomachine.

Preferably, the outer stator annular sectors are identical and interchangeable with each other and the number of the elementary stator and rotor magnetic circuits per annular sector is not identical to the stator and to the rotor.

Advantageously, the outer stator annular sectors are electrically interconnected with each other by interconnection parts accessible for the mounting/dismounting through circumferential access hatches and the inner rotor annular sectors are electrically interconnected with each other and accessible for the mounting/dismounting through the circumferential access hatches.

Preferably, the inner and outer magnetic cores are formed of a stack of laminations, wound laminations or a block of magnetic powder.

Advantageously, the stack of laminations is in the form of packets of laminations of a magnetic material such as FeSi, FeNi or FeCo, the wound laminations in the form of magnetic material of the amorphous or nanocrystalline type, and the block of magnetic powder in the form of amorphous powder.

Preferably, the outer magnetic core has a C or U shape ending with the expansions at the level of the air gap and the inner magnetic core has an H shape defining the expansions at the level of the air gap.

Advantageously, the expansions are formed by bars with a notch allowing the branches of the C or U to be inserted therein and thus offer a larger contact surface between the branches and the bars.

According to one exemplary embodiment, the U-shaped outer magnetic core results from cutting a magnetic torus formed of a wound lamination into two portions and the expansions result from cutting a cylindrical magnetic torus of wound laminations into four quarter rounds.

According to another exemplary embodiment, the outer magnetic core results from interlocking three U-shaped lamination packets.

According to yet another exemplary embodiment, the outer magnetic core results from a C-shaped part, whose portions on either side of a central portion have been machined to obtain the expansions at the level of the air gap.

### BRIEF DESCRIPTION OF THE DRAWINGS

Other characteristics and advantages of the present invention will emerge more clearly from the description given below, with reference to the appended drawings which illustrate exemplary embodiments thereof without any limitation and in which:

FIG. 1 illustrates a portion of an aircraft turbomachine integrating a rotating transformer in accordance with the invention,

FIG. 2 shows a quarter of the rotating transformer of FIG. 1,

FIG. 3 shows a first example of stator and rotor magnetic circuits making up the rotating transformer quarter of FIG. 2,

FIG. 4 shows a second example of stator and rotor magnetic cores making up the rotating transformer quarter of FIG. 2,

FIG. 5 shows a third example of stator and rotor magnetic cores making up the rotating transformer quarter of FIG. 2,

FIG. 6 illustrates one variant of the stator for the third example of stator and rotor magnetic cores making up the rotating transformer quarter of FIG. 2,

FIG. 7 shows a fourth example of stator and rotor magnetic cores making up the rotating transformer quarter of FIG. 2, and

FIG. 8 shows a fifth example of stator and rotor magnetic cores making up the rotating transformer quarter of FIG. 2.

### DESCRIPTION OF THE EMBODIMENTS

The principle of the invention implemented is based on a segmentation of the rotating transformer into several annular sectors or quarters each having a mass and a replacement time compatible with a ground maintenance operation limiting the downtime of the aircraft, so that the replacement interventions (mounting/dismounting) are facilitated and can be carried out by a conventional tooling through dedicated access hatches, without having to dismount or interfere with the other portions of the aircraft turbomachine.

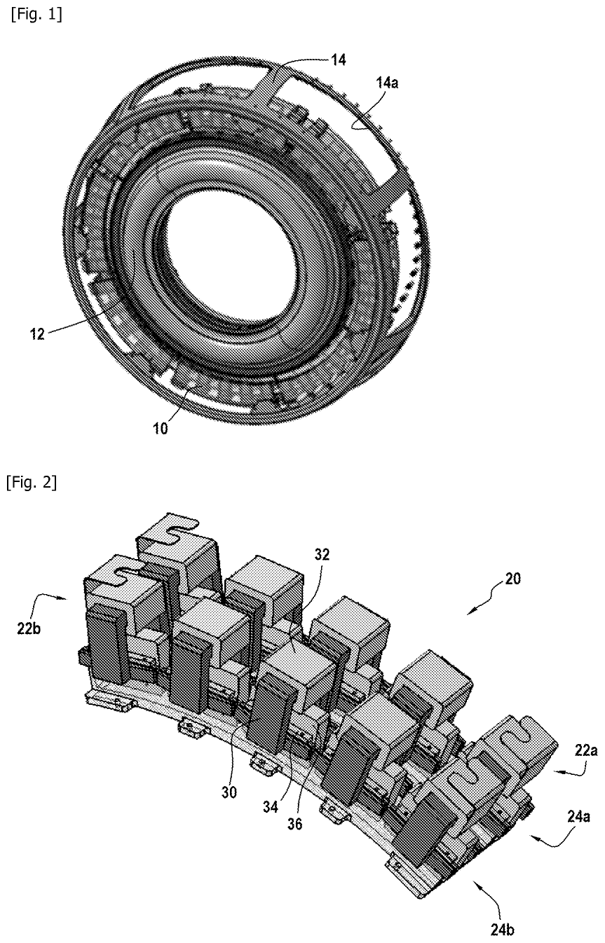

As shown in FIG. 1 which is a part of an aircraft turbomachine, the rotating transformer 10 according to the invention is mounted between a transmission shaft 12 movable in rotation forming a rotating portion of the turbomachine and a casing 14 forming a fixed portion of the turbomachine, provided with circumferential access hatches 14a through which each of the annular quarters or sectors of the rotating transformer can be installed or easily removed for repair or maintenance and then reinstalled once these replacement interventions have been carried out.

FIG. 2 illustrates more specifically an annular sector or quarter 20 of the rotating transformer 10 which in the example illustrated includes two axially offset redundant paths (bearing the references a and b), each consisting of a fixed stator quarter 22a, 22b secured to the casing and a rotating rotor quarter 24a, 24b secured to the transmission shaft, the rotor and stator quarters of each path, mounted concentrically, being separated by an air gap (visible in the following figures). The rotating transformer formed by the juxtaposition over 360° of several quarters 20 has a large diameter, of the order of one meter and more, which allows the rotor to receive a transmission shaft also of large diameter, such as a propeller shaft.

According to the invention, the juxtaposition over 360° of these different annular sectors to the stator and to the rotor form an outer stator ring and an inner rotor ring consisting of a plurality of single-phase elementary stator and rotor magnetic circuits including respectively a stator magnetic core 30 and a first (primary 32) electrical winding and a rotor magnetic core 34 and a second (secondary 36) electrical winding, the stator and rotor magnetic cores being separated by the same air gap present on either side of the rotor magnetic core and the sectors being able to be electrically interconnected in series or in parallel for the transmission of electrical energy by electromagnetic induction between the first and second electrical windings of these elementary stator and rotor magnetic circuits. The annular sectors are identical both to the stator and to the rotor and interchangeable with each other. On the other hand, the number of these elementary magnetic circuits per annular sector is not necessarily identical to the stator and to the rotor, the choice of the number of magnetic circuits to the stator and to the rotor being guided by design and transfer performance optimization considerations.

An annular sector to the stator or to the rotor is designed as a LRU (Line Replaceable Unit) dismountable and replaceable under the wing through the circumferential access hatches 14a. They are electrically interconnected by interconnection parts (not referenced) also accessible for the mounting/dismounting through the circumferential access hatches 14a.

It should be noted that in the illustrated case where the power transfer solution is redundant, an annular sector to the stator or to the rotor is made up of all the elements of two identical paths placed side by side in the axial plane.

Depending on the envisaged frequency of use, the type of material used for the magnetic core could be different. Thus, for a low-frequency use, a stack in the form of packets of laminations of a magnetic material such as FeSi, FeNi or FeCo is envisaged for both the stator and the rotor. For medium or high-frequency use, a magnetic core made of wound lamination of the amorphous or nanocrystalline type or in the form of a block of powder of any other suitable magnetic material (for example made of amorphous powder) is envisaged for the stator and the rotor. A mixture of materials can however be envisaged with a stator made of medium or high-frequency material and a rotor made of low-frequency material or vice versa.

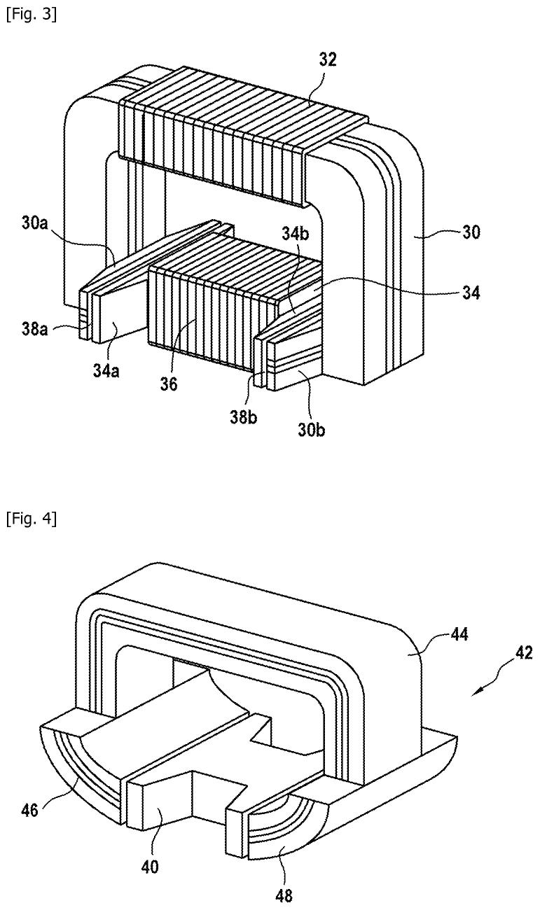

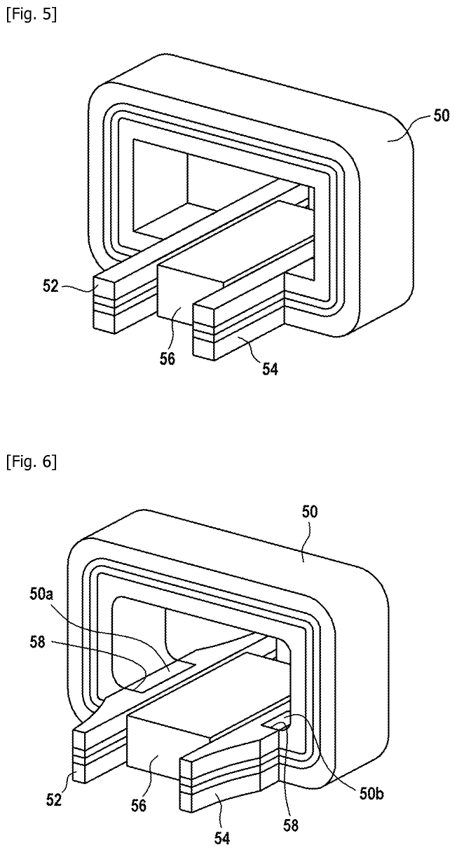

FIGS. 3 to 8 show different possible topologies for each elementary magnetic circuit to the stator and to the rotor allowing the production of the rotating transformer according to the invention. It should be noted that such a magnetic circuit can be installed horizontally (axial air gap as illustrated) or vertically (radial air gap). These topologies all have in common the fact that the stator magnetic cores (or outer stator cores 30) have expansions 30a, 30b at the level of each of the two air gaps 38a, 38b which correspond to the stator and which, by avoiding a discontinuity of the magnetic field lines during the rotation of the movable shaft, improve the efficiency of the power transfer. The rotor magnetic cores (or inner rotor cores 34) also may or may not have expansions 34a, 34b (see for example FIGS. 5 and 6). It will be noted that, for reasons of simplification, the electrical windings 32, 36 which are not represented in FIGS. 4 to 8 showing only the stator and rotor magnetic cores, can be wired or ribbon windings according to the different integration and performance constraints to be met, and the series of three lines appearing on the magnetic cores tend to show the arrangement of the laminations constituting them.

In FIG. 3, corresponding to a low-frequency use, the outer or stator magnetic core 30 has a U shape ending with expansions 30a, 30b at the level of the two axial air gaps 38a, 38b. The inner or rotor magnetic core 34 has an H shape defining expansions 34a, 34b at the level of these two axial air gaps present on either side of the inner magnetic core 34.

FIG. 4 presents an economical production without waste of materials corresponding to a use in medium or high frequency and in which the inner magnetic core 40 has an H shape obtained by a stack of laminations in the vertical plane and the outer magnetic core 42 is made up of an assembly of three parts, namely a U-shaped part 44 resulting from cutting into two portions a magnetic torus formed of a wound lamination and two expansions 46, 48 resulting from cutting into four quarter rounds a cylindrical magnetic torus of wound laminations. The shape of the expansions can of course be adapted for reasons of mass saving by modifying the width at the level of the junction surface between the expansion and the U-shaped part 44.

In FIG. 5, the C-shaped outer magnetic core 50 is cut at the level of the air gap to leave room for the addition of a bar 52, 54 on each side of the cutout to form the expansions between which the I-shaped inner magnetic core 56, therefore without expansions, is placed. As illustrated in FIG. 6, these bars 52, 54 could advantageously each have a notch 58 allowing the branches 50a, 50b of the C-shaped part in order to be inserted therein and thus offer a larger contact surface between the two parts (C/bar).

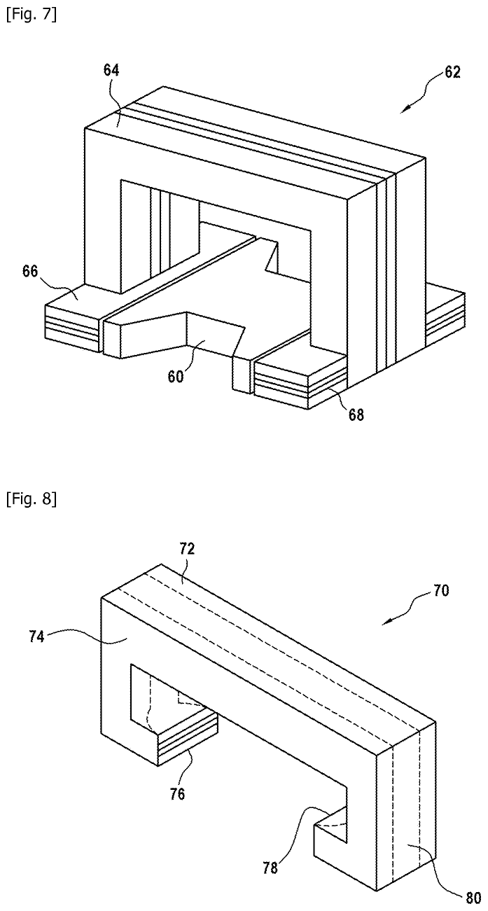

In the exemplary embodiment of FIG. 7, more specifically adapted to a low-frequency use and also without wasting materials when cutting, the inner magnetic core 60 also has an H shape by a stack of laminations in the vertical plane and the outer magnetic core 62 is composed of an interlocking of three U-shaped lamination packets 64, 66, 68.

Finally, FIG. 8 shows another particularly robust exemplary embodiment with an outer magnetic core obtained by the simple machining of a C-shaped part 70 having an initial width equal to that of the expansions at the level of the air gap as illustrated. The material corresponding to the portions 72, 74 and without touching the portions 76, 78 forming the expansions, is removed along the cutting lines illustrated in dotted lines in the figure to leave only the central portion 80. This gives a final magnetic core with a width smaller than the expansion at the level of the passage of the electrical winding. The inner magnetic core (not represented) can be H-shaped or I-shaped.

If as an application, reference has been made to the de-icing of the propeller airfoils of an aircraft turbomachine, among the other possible applications, in particular in the aeronautical industry, which can benefit from the use of rotating transformers, we can cite the feedback of information from torque sensors for the variable pitch of blades in the airplanes and the setting of the propeller pitch in helicopters, for example. For such applications, the elimination of the conventional rubbing brush commutator and its replacement by a rotating transformer is advantageous because it makes the equipment more reliable by eliminating the risk of failure created by the wear of the brushes.

1. A rotating transformer intended to be installed around a shaft movable in rotation, the rotating transformer consisting of a plurality of outer stator annular sectors and a plurality of inner rotor annular sectors, the juxtaposition over 360° of these outer stator and inner rotor annular sectors forming an outer stator ring and an inner rotor ring consisting of elementary stator and rotor magnetic circuits, each of the elementary stator magnetic circuits including an outer magnetic core and a first electrical winding and each of the elementary rotor magnetic circuits including an inner magnetic core and a second electrical winding to allow a transfer of electrical energy by electromagnetic induction between the outer stator and inner rotor rings, the inner and outer magnetic cores being mounted concentrically and separated by two axial air gaps present on either side of the inner magnetic core, characterized in that at least the outer magnetic cores have expansions at the level of each of the two air gaps to avoid a discontinuity of the magnetic field lines during the rotation of the movable shaft and in that the inner rotor annular sectors are identical and interchangeable with each other.

2. The rotating transformer according to claim 1, wherein the outer stator annular sectors are identical and interchangeable with each other.

3. The rotating transformer according to claim 1, wherein the number of the elementary stator and rotor magnetic circuits per annular sector is not identical to the stator and to the rotor.

4. The rotating transformer according to claim 1, wherein the outer stator annular sectors are electrically interconnected with each other by interconnection parts accessible for the mounting/dismounting through circumferential access hatches.

5. The rotating transformer according to claim 4, wherein the inner rotor annular sectors are electrically interconnected with each other and accessible for the mounting/dismounting through the circumferential access hatches.

6. The rotating transformer according to claim 1, wherein the inner and outer magnetic cores are formed of a stack of laminations, wound laminations or a block of magnetic powder.

7. The rotating transformer according to claim 6, wherein the stack of laminations is in the form of packets of laminations of a magnetic material such as FeSi, FeNi or FeCo, the wound laminations in the form of magnetic material of the amorphous or nanocrystalline type, and the magnetic powder block in the form of amorphous powder.

8. The rotating transformer according to claim 1, wherein the outer magnetic core has a C or U shape ending with the expansions at the level of the air gap and the inner magnetic core has an H shape defining the expansions at the level of the air gap or an I shape without expansions.

9. The rotating transformer according to claim 8, wherein the expansions are formed by bars with a notch allowing the branches of the C or U to be inserted therein and thus offer a larger contact surface between the branches and the bars.

10. The rotating transformer according to claim 8, wherein the outer magnetic core results from cutting a magnetic torus formed of a wound lamination into two portions and the expansions result from cutting a cylindrical magnetic torus of wound laminations into four quarter rounds.

11. The rotating transformer according to claim 8, wherein the outer magnetic core results from interlocking three U-shaped lamination packets.

12. The rotating transformer according to claim 8, wherein the outer magnetic core results from a C-shaped part whose portions on either side of a central portion have been machined to obtain the expansions at the air gap.

13. A use of a rotating transformer according to claim 1, for the electrical de-icing of the propeller airfoils of an aircraft turbomachine.
